(19) United States
(12) Patent Application Publication
(10) Pub. No.: US 2016/0116803 A1
(43) Pub. Date: Apr. 28, 2016

(54) DISPLAY PANEL WITH IMPROVED ALIGNMENT FORCE ADJACENT TO SPACER THEREOF

(71) Applicant: Innolux Corporation, Chu-Nan (TW)

(72) Inventors: Bo-Chin TSUEI, Chu-Nan (TW); Hang-Lang LEE, Chu-Nan (TW); Kuei-Ling LIU, Chu-Nan (TW)

(21) Appl. No.: 14/602,191

(22) Filed: Jan. 21, 2015

(30) Foreign Application Priority Data
Oct. 28, 2014 (TW) 103137197

(51) Int. Cl. G02F 1/1337; G02F 1/1335; G02F 1/1339

(52) U.S. Cl. CPC G02F 1/133753; G02F 1/13394; G02F 1/133514; G02F 1/133512; G02F 1/133528; G02F 1/133788; G02F 1/133723

(57) ABSTRACT

A display panel comprises a first substrate, a second substrate, a liquid crystal layer disposed between the first substrate and the second substrate, a light-shielding layer disposed between the liquid crystal layer and the second substrate, plural spacers, and an alignment film disposed between the first substrate and the second substrate. The alignment film comprises a first region near the spacer and a second region adjacent to the first region. The second region is positioned outside the first region and corresponds to the light-shielding layer. The first region has a first phase value (S1) and a first roughness value (R1). The second region has a second phase value (S2) and a second roughness value (R2). The ratio (S1/R1) of the first phase value to the first roughness value is larger than the ratio (S2/R2) of the second phase value to the second roughness value.

This application claims the benefit of Taiwan application Serial No. 103137197, filed Oct. 28, 2014, the subject matter of which is incorporated herein by reference.

### BACKGROUND OF THE INVENTION

1. Field of the Invention

The invention relates in general to a display panel, and more particularly to a display panel with improved alignment force adjacent to the spacer thereof.

2. Description of the Related Art

Electronic products with display panel have become indispensable necessities to modern people in their work, studies or entertainment. Examples of the electronic products comprise smartphones, PC tablets, notebooks, monitors and TVs. Of those electronic products, liquid crystal display (LCD) panel is the most popular.

LCD panel uses voltage to drive liquid crystals (LCs) and accordingly adjust brightness grayscales to form flat panel display, electronic visual display, and image display. LCD panel has the advantages of simplicity, lightweight, lower cost and higher reliability and is friendly to eyes in most applications. LCD panel has replaced cathode ray tube (CRT) display and become the most popular display. LCD also provides a range of selection comprising size, shape and resolution. Since the liquid crystal molecules near the spacer, which separates the upper substrate and the lower substrate of conventional display panel, tilt along the surface of the spacer, light leakage surrounding the spacer may easily occur in the dark state.

### SUMMARY OF THE INVENTION

The disclosure is related to a display panel in which the pre-tilt angle of the liquid crystal molecules near the spacer can be adjusted through the increase in the alignment force adjacent to the spacer, such that the light leakage beside the spacer can be reduced and the light leakage in the dark state can be resolved. The pre-tilt angle of the liquid crystal molecules near the spacer is originally affected by the spacer

According to one embodiment of the present invention, the alignment force adjacent to the spacer is increased through the increase in the degree of phase separation of the photo alignment film near the spacer.

According to one embodiment of the present invention, a display panel is disclosed. The display comprises a first substrate, a second substrate, a liquid crystal layer disposed between the first substrate and the second substrate, a light-shielding layer disposed between the liquid crystal layer and the second substrate, plural spacers, and an alignment film disposed between the first substrate and the second substrate. The alignment film comprises a first region near the spacer and a second region adjacent to the first region. The second region is positioned outside the first region and corresponds to the light-shielding layer. The first region has a first phase value (S1) and a first roughness value (R1). The second region has a second phase value (S2) and a second roughness value (R2). A ratio (S1/R1) of the first phase value to the first roughness value is larger than a ratio (S2/R2) of the second phase value to the second roughness value. (The values of S1, S2, R1 and R2 are measured in the same circumstance.)

According to another embodiment of the present embodiment, a display device comprising the display panel described above and a backlight module is disclosed. The backlight module is disposed on a side of the display panel for providing a light to the display panel.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a partial top view of a display panel according to an embodiment of the disclosure.

FIG. 2 is a cross-sectional view of one of a plurality of sub-pixels of a display panel according to an embodiment of the disclosure.

FIG. 3A is a schematic diagram of the periphery of a spacer of a conventional display panel in a normal black mode.

FIG. 3B is a schematic diagram of the periphery of a spacer of a display panel according to an embodiment of the disclosure.

FIG. 3C is a schematic diagram of a pre-tilt angle of liquid crystal molecules.

FIG. 4A is a schematic diagram of a coating material of a photo alignment film.

FIG. 4B is a schematic diagram showing phase separation after the photo alignment film is baked.

FIG. 5 is a schematic diagram of a process for baking a photo alignment film according to an embodiment of the disclosure.

FIG. 6 shows a diagram of ratios of phase value to roughness value of a photo alignment film measured at three sampling positions (sample 1, sample 2 and sample 3) by using an atomic force microscope and formed by using a baking process according to an embodiment of the disclosure.

FIG. 7A shows several patterns of dark fringes corresponding to the pre-tilt angles of 0.5, 1, 1.5 and 2 according to an embodiment of the disclosure.

FIG. 7B shows a relationship of front-view transmittance versus pre-tilt angles of 0.5, 1, 1.5 and 2 according to an embodiment of the disclosure.

FIG. 8 shows the relationships of the phase value/roughness value ratios of RGB sub-pixels measured at sampling positions (sample 4 and sample 5) according to an embodiment of the disclosure in which the alignment force is improved.

### DETAILED DESCRIPTION OF THE INVENTION

The disclosure discloses a display panel in which the pre-tilt angle of the liquid crystal molecules near the spacer can be adjusted through the increase in the alignment force adjacent to the spacer, such that the light leakage beside the spacer can be reduced and the light leakage in the dark state can be resolved. The pre-tilt angle is originally affected by the spacer. The disclosure can be used in the display panel having a photo alignment film. In an embodiment, the degree of phase separation of the photo alignment film adjacent to the spacer is increased through the increase in the alignment force adjacent to the spacer.

A number of implementations are described below with accompanying drawings. It should be noted that the structures and contents disclosed in the embodiments are exemplary and explanatory only, and the scope of protection of the disclosure is not limited to the implementations. In the accompanying diagrams, the same numeric designations indicate the same or similar components. Since the disclosure does not provide all possible embodiments, necessary modifications or variations can be made to the structures and protection of the disclosure to meet actual needs provided that the spirit and scope of protection of the disclosure are not violated. Therefore, the display panel of the disclosure can also be used in other embodiments not disclosed in the disclosure. It should be noted that accompanying drawings are simplified so as to provide clear descriptions of the embodiments of the disclosure, and the scales used in the drawings are not based on the scales of actual products. However, the following detailed descriptions are exemplary and explanatory only, not for limiting the scope of protection of the disclosure.

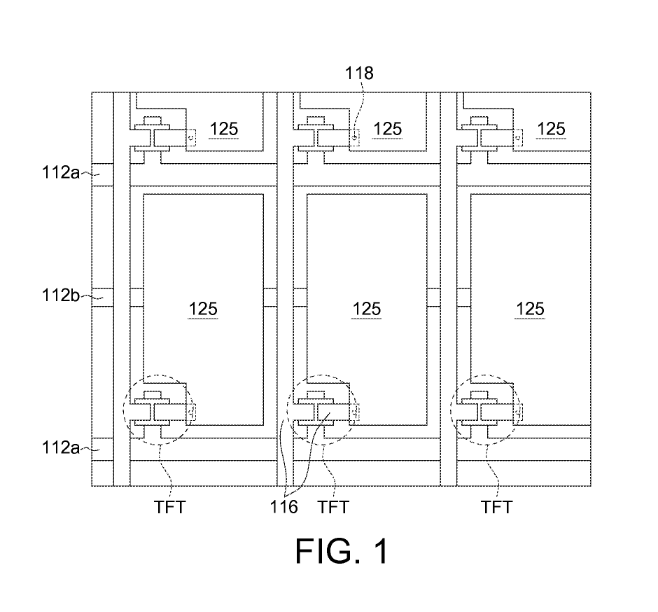

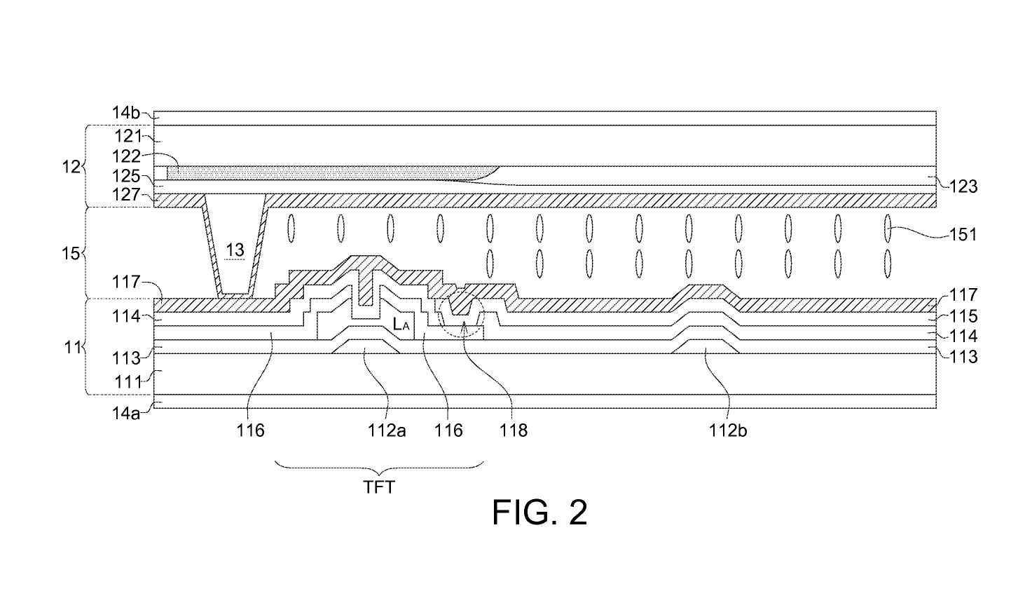

FIG. 1 is a partial top view of a display panel according to an embodiment of the disclosure. FIG. 2 is a cross-sectional view of one of a plurality of sub-pixels of a display panel according to an embodiment of the disclosure. For components common to FIG. 1 and FIG. 2, the same numeric designations are used for the convenience of description. Refer to FIG. 1 and FIG. 2. In an embodiment, the display panel is disposed in a display device; the display device and a backlight module (not illustrated) are disposed in a frame; the backlight module is disposed on a side of the display panel (such as under the display panel) for providing a light source with high brightness to the display panel.

In the present embodiment, the display panel comprises a first substrate 11, a second substrate 12, and a liquid crystal layer 15 disposed between the first substrate 11 and the second substrate 12. The first substrate 11 and the second substrate 12 can be realized by a thin film transistor substrate (TFT substrate) and a color filter substrate (CF substrate) respectively. A relevant structure is disclosed below for elaborating the present embodiment. However, the structure disclosed in the present embodiment is not for limiting the scope of protection of the disclosure. The first substrate 11 and the second substrate 12 assembled to each other can be realized by a color filter substrate and a TFT substrate respectively, and the present disclosure is not limited thereto.

As shown in FIG. 1, the first substrate 11 of the present embodiment comprises a first base 111, a first transparent conducting layer 115 and a first alignment film 117 disposed on the first transparent conducting layer 115. The first alignment film 117 can be realized by a photo alignment film (ex. polyimide, PI) and a pixel electrode can be realized by a transparent conductive layer (ex. an ITO layer or an IZO layer). The pixel electrode can be a planar electrode or a patterned electrode with slits. The first substrate 11 further comprises a plurality of patterned traces (patterned traces or conductive traces) 112 (comprising a patterned first metal layer 112a or/and a common line 112b) and a plurality of transistors TFT formed on the first base 111. Refer to FIG. 1 and FIG. 2 at the same time. Each sub-pixel comprises a transistor TFT. The structure of the transistor TFT comprises, for example, a patterned first metal layer 112a (defined as a gate), a first middle layer 113 (such as a gate insulating layer), an active layer LA, a patterned second metal layer 116 (defined as a source/drain region) and a protection layer 114. Moreover, the first middle layer 113 is also disposed between the first base 111 and the first transparent conducting layer 115 and covers the patterned trace 112. The portion of the protection layer 114 corresponding to the patterned second metal layer 116 has a contact hole 118. The first transparent conducting layer 115 is electrically connected to the second metal layer 116 through the contact hole 118. Details of the layer structure (comprising TFT) and disposition of the first substrate 11 are generally known to those who are skilled in the art of the disclosure, and are not repeated here.

As shown in FIG. 2, the second substrate 12 of the present embodiment comprises a second base 121, a second transparent conducting layer 125 and a second alignment film 127 disposed on the second transparent conducting layer 125. The second alignment film 127 can be realized by a photo alignment film formed of polyimide. The second transparent conducting layer 125 can be realized by an ITO layer. The second substrate 12 further comprises a light-shielding layer 122 (ex. black matrix, BM) and a second middle layer (ex. color filter photoresist layer (color filter, CF)) 123 formed on the second base 121. If the second middle layer 123 is realized by a color photoresist layer, a flat layer, an insulating layer, or an organic layer, the second middle layer 123 can be disposed between the light-shielding layer 122 and the second alignment film 127. In some embodiments, a flat layer or an insulating layer can be disposed between the second middle layer 123 and the second transparent conducting layer 125. In the present embodiment, the second substrate 12 further comprises a plurality of spacers 13 formed on the second transparent conducting layer 125, and the second alignment film 127 contacts and covers the spacer 13. In the present embodiment, the light-shielding layer 122 correspondingly shields the spacer 13, the transistor TFT and the contact hole 118. The spacer 13 maintains a substantially uniform gap between the first substrate 11 and the second substrate 12, and a liquid crystal layer 15 (formed of liquid crystal molecules) is disposed in the space between the second substrate 12 and the first substrate 11.

Moreover, a first polarizer 14a and a second polarizer 14b are disposed outside the first base 111 and the second base 121 respectively.

In some embodiments, the spacer can be disposed on the first substrate (not illustrated) and covered by an alignment film. In another embodiment, the light-shielding layer can also be disposed on the first substrate (not illustrated).

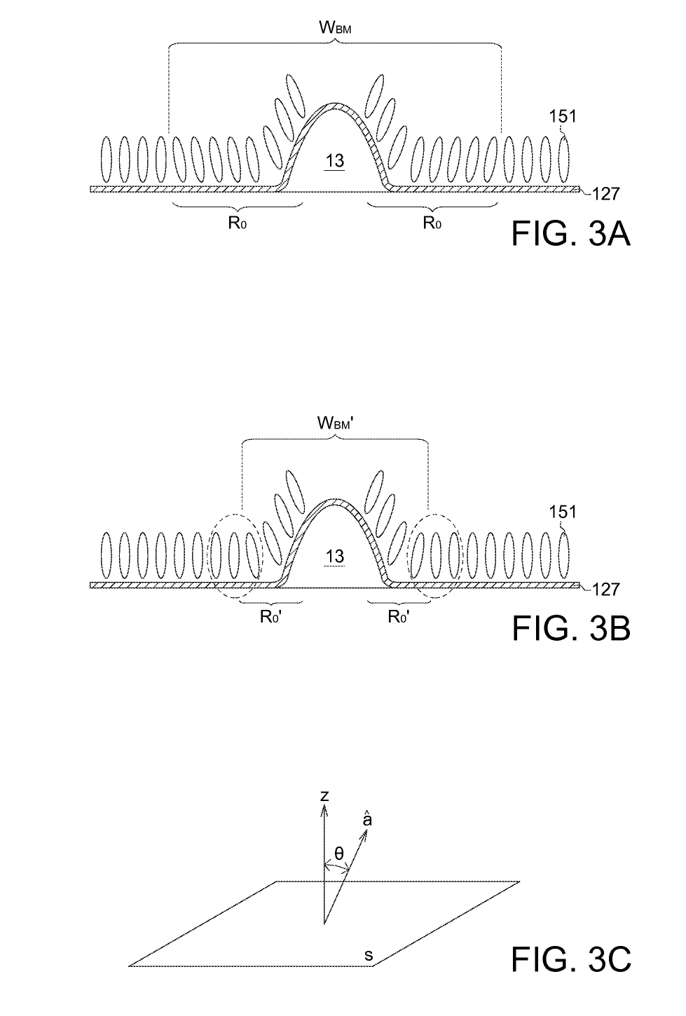

Referring to FIG. 3A and FIG. 3B, effects of the present disclosure are disclosed. FIG. 3A is a schematic diagram of the periphery of a spacer of a conventional display panel in a normal black mode. Suppose that the conventional display panel in a normal black mode is in a dark state and the liquid crystal molecules 151 are arranged in a continuous manner with the long axes tilting towards the contact surface (along the direction of the main chain of the liquid crystal molecules). Therefore, when the liquid crystal molecules 151 are tilted at a large angle along the topography of the spacer 13, the liquid crystal molecules have tilt angles, a light leakage region R₀ is formed surrounding the spacer 13, mura is generated accordingly, and the light-shielding layer correspondingly shields the light leakage region R₀ by a width such as the width W_{BM} of the black matrix. FIG. 3B is a schematic diagram of the periphery of a spacer of a display panel according to an embodiment of the disclosure. The display panel of the present embodiment changes the pre-tilt angle of the liquid crystal molecules near the spacer 13 through the increase in the alignment force adjacent to the spacer 13. As indicated in FIG. 3A and FIG. 3B, the tilt angle of some liquid crystal molecules (that is, close to the spacer 13) in the dark state is smaller than that of a conventional display panel (when the alignment force is stronger, the tilt angle of the liquid crystal molecules is closer to the pre-tilt angle). Since the light leakage region R₀′ formed near the spacer 13 is smaller than the conventional light leakage region R₀, the light leakage in the dark state is thus reduced. Since the light-shielding layer (such as black matrix) correspondingly shielding the light leakage region R₀′ of the present embodiment has a width W_{BM} (FIG. 3B) narrower than the width W_{BM} (FIG. 3A) of the conventional light-shielding layer, the aperture ratio of sub-pixels can further be increased.

In the display panel with a photo alignment film (ex. formed of polyimide, PI) according to an embodiment of the disclosure, the shielding width of the light-shielding layer can be reduced through the reduction in the light leakage region (the mura area as well). For example, the alignment force can be increased through the increase in the degree of phase separation of the photo alignment film adjacent to the spacer 13, and the pre-tilt angle of the liquid crystal molecules near the spacer 13 can be increased accordingly. Thus, the degree of phase separation of the photo alignment film (formed of PI) can be monitored according to the data of phase value/roughness value ratio, the data of phase value and the data of roughness value are obtained by using an atomic force microscope (AFM) under the same measurement conditions, and the higher the ratio, the more complete the phase separation. As the degree of phase separation gets more complete, the photo alignment film (formed of PI) has higher control over the liquid crystal molecules, such that the liquid crystal molecules have larger pre-tilt angle (the angle formed by the long axis of liquid crystal molecules and the Z-axis perpendicular to the substrate S). FIG. 3C is a schematic diagram of a pre-tilt angle of liquid crystal molecules, wherein the Z-axis is a vector perpendicular to the substrate S, â is a long axis of liquid crystal molecules, and θ is a pre-tilt angle of liquid crystal molecules formed by the Z-axis and the vector â.

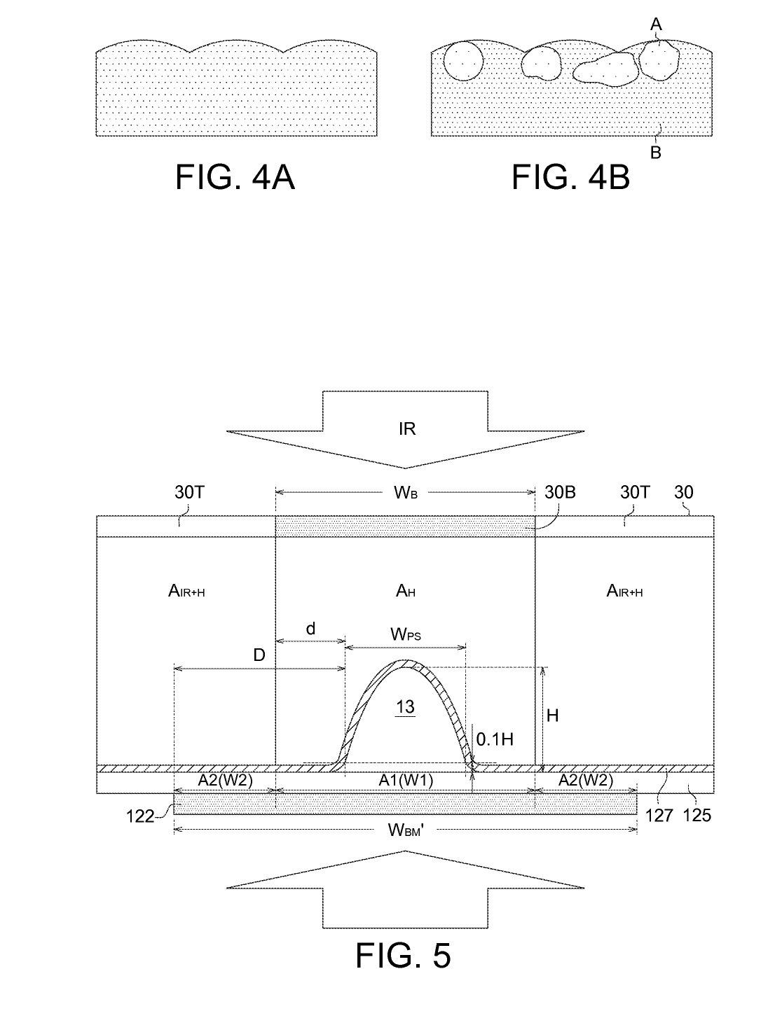

In the photo alignment film of an embodiment, at least two types of polymer monomers with different polarities are mixed in a solvent. For example, one type of monomers contains a UV reactive side chain (such as F), but the other type of monomers does not contain the UV reactive side chain. FIG. 4A is a schematic diagram of a coating material of a photo alignment film. FIG. 4B is a schematic diagram showing phase separation after the photo alignment film is baked. After the photo alignment film is baked in the air environment (the air tends to be nonpolar), monomers A with lower polarity (the monomer containing a UV reactive side chain) will move towards the air (floating) and form phase separation with monomers B having higher polarity. When polarity difference between two types of polymer monomers reaches a certain degree, black spots on the phase value-separated photo alignment film will be observed by using an atomic force microscope (AFM). That is, phase value difference between the two types of monomers is large. Following the baking process, the photo alignment film is radiated by a UV light to assure the alignment direction of the photo alignment film.

Table 1 shows AFM data of phase value, roughness value, and phase value/roughness value ratio for the coated photo alignment film (corresponding to FIG. 4A) and the baked photo alignment film (corresponding to FIG. 4B). Before the baking process is performed, the monomers A and the monomers B do not generate phase separation, the monomers A and the monomers B have similar AFM data of phase value and roughness value, and the phase value/roughness value ratio is a straight line. After the baking process is completed, the monomers A and the monomers B already generated phase separation, so that the monomers A floated to the layer surface can be clearly viewed in the AFM data of phase value and the phase value/roughness value ratio. It should be noted that the protrusions illustrated in FIG. 4A, FIG. 4B and Table 1 merely indicate that phase separation is generated between the monomers A and the monomers B after the photo alignment film is baked. The illustration of protrusions does not represent actual protrusions on the material layer nor does it represent actual contour of the surface of the alignment film.

TABLE 1

| | After the photo alignment | After the photo alignment |
|---|---|---|
| | film is coated | film is baked |
| | (corresponding to FIG. 4A) | (corresponding to FIG. 4B) |
| Phase value | 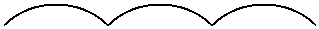 | 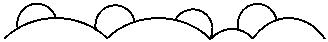 |
| Roughness value | 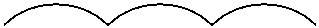 | 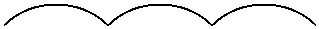 |
| Phase value/ Roughness | 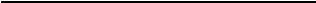 | 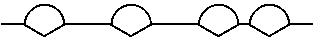 |
| value | | |

Phase value/roughness value indicates the desired proportion of phase value, and the larger the proportion of phase value, the higher the degree of phase separation of the photo alignment film, and the stronger the alignment force. Therefore, in the present embodiment, the alignment force can be increased through the increase in the degree of phase separation of the photo alignment film adjacent to the spacer 13, and the range of the light leakage region near the spacer 13 is reduced through the adjustment in the pre-tilt angle of the liquid crystal molecules near the spacer 13.

An implementation of generating phase separation for the photo alignment film adjacent to the spacer is disclosed below with accompanying drawings. However, the disclosure is not limited to the drawing and descriptions.

FIG. 5 is a schematic diagram of a process for baking a photo alignment film according to an embodiment of the disclosure. FIG. 5 only illustrates a light-shielding layer 122, a second alignment film 127 and a spacer 13, and other layers and components are omitted. In the baking process of an embodiment, a mask 30 is placed above the spacer 13, and a baking process is conducted by an infrared light IR. Also, the underneath of the spacer 13 is uniformly heated by a heater. The mask 30 with special pattern design has a transmissive region 30T and a blocking region 30B (the light-shielding portion has a width W_{B}). That is, the portions of the mask 30 corresponding to the peripheral region A_{H} of the spacer 13 and the region A_{IR+H} outside the spacer 13 are the blocking region 30B and the transmissive region 30T, respectively, such that the peripheral region A_{H} of the spacer 13 is baked at a lower baking temperature. Since lower baking temperature makes the solvent of the photo alignment film evaporated at a lower evaporation rate, the monomers in the solvent can travel at a faster rate and reach a higher degree of phase separation in the peripheral region A_{H} of the spacer 13, and the alignment force generated in the peripheral region A_{H} of the spacer 13 is stronger than that generated in the region A_{IR+H}. During the baking process, the region A_{IR+H} is baked by an infrared light IR and a heater at the same time. Since the baking temperature in the region A_{IR+H} is higher than that in the region A_{H}, the solvent in the region A_{IR+H} is evaporated at a higher evaporation rate (the overall viscosity is increased), the monomers cannot travel easily, and the degree of phase separation is reduced. After the baking process is completed, the mask 30 is removed, and the photo alignment film is irradiated by a UV light to assure the alignment direction of the photo alignment film. Then, the upper substrate and the lower substrate are assembled to each other, and liquid crystal molecules are disposed between the two substrates.

In practical application, other techniques capable of baking the peripheral region A_{H} and region A_{IR+H} at different temperatures can also be used in addition to the above technique. Any techniques can be used in the disclosure as long as the baking temperature T1 in the region A_{H} is lower than the baking temperature T2 in the region A_{IR+H}, such that the degree of phase separation can be differentiated and the alignment force in the peripheral region A_{H} of the spacer 13 is higher than that in the region A_{IR+H}.

Also, in practical application, the alignment force of the photo alignment film is not increased entirely. This is because the alignment force at the opening area is related to optical properties, and the alignment force is increased only in the region adjacent to the spacer 13 (such as the region A_{H}), not in an entire or arbitrary manner.

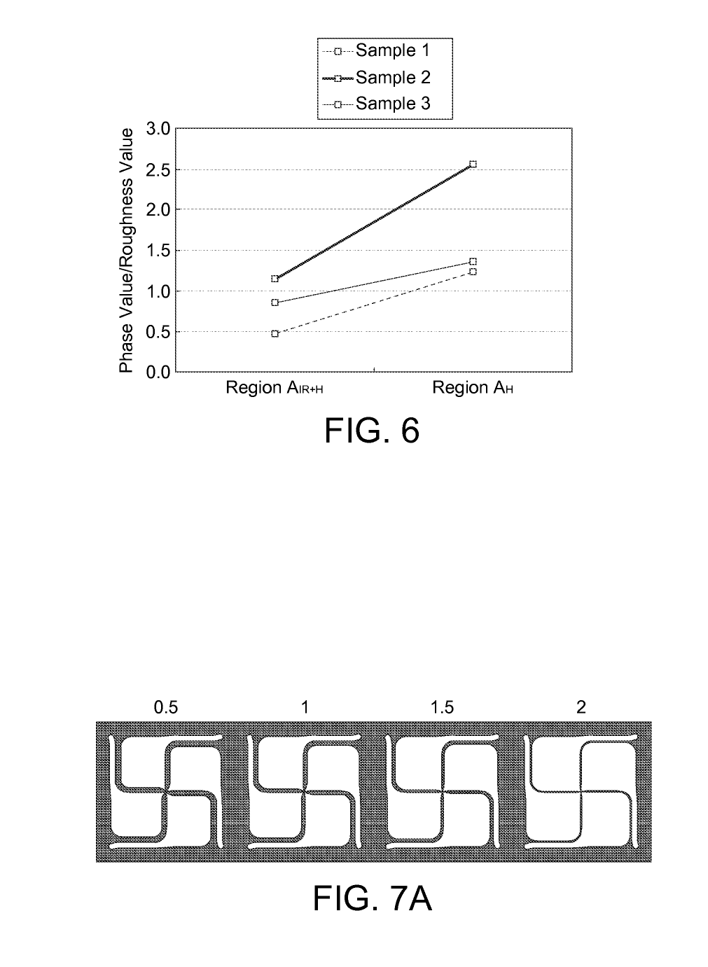

FIG. 6 shows a diagram of ratios of phase value to roughness value of a photo alignment film measured at three sampling positions (sample 1, sample 2 and sample 3) by using an atomic force microscope and formed by using a baking process according to an embodiment of the disclosure. Noted that sample 1, sample 2 and sample 3 are obtained under the same measurement conditions. The phase value/roughness value ratios measured at three sampling positions (sample 1, sample 2 and sample 3) of the peripheral region A_{H} of the spacer 13 are higher than the phase value/roughness value ratios measured at three sampling positions (sample 1, sample 2 and sample 3) of the region A_{IR+H}. The roughness value as measured herein can be value of average roughness, Ra (which is the arithmetic average of the absolute values of the roughness profile ordinates), or value of root mean squared (RMS) roughness, Rg (which is the root mean square average of the roughness profile ordinates).

Refer to FIG. 1 and FIG. 5 again. As indicated in the display panel of the present embodiment, the spacer 13 separates the second substrate 12 and the first substrate 11 from each other by an equal distance, the vertical projection of the spacer on the second substrate 12 has a maximum width W_{PS}, the light-shielding layer 122 is disposed between the liquid crystal layer 15 and the second substrate 12 corresponds to the spacer 13. The alignment film (such as the second alignment film 127) is disposed between the first substrate 11 and the second substrate 12, and comprises a first region A1 near the spacer 13 and a second region A2 adjacent to the first region A1. The second region A2 corresponds to the light-shielding layer 122, and is positioned outside the first region A1. In an embodiment, the second region A2 surrounds the first region A1. After the degree of phase separation is differentiated for the alignment film by using the technique as illustrated in FIG. 5 (by coating the photo alignment film and baking the mask 30), the first region A1 has a first phase value S1 and a first roughness value R1. The second region has a second phase value S2 and a second roughness value R2. In an embodiment, the ratio P1 (S1/R1) of the first phase value S1 to the first roughness value R1 is larger than the ratio P2 (S2/R2) of the second phase value S2 to the second roughness value R2.

In an embodiment, the difference between the ratio P1 (S1/R1) of the first phase value S1 to the first roughness value R1 and the ratio P2 (S2/R2) of the second phase value S2 to the second roughness value R2 is at least larger than 0.5 but smaller than 5 (5>(P1−P2)>0.5). In another embodiment, the ratio P1 (S1/R1) of the first phase value S1 to the first roughness value R1 and the ratio P2 (S2/R2) of the second phase value S2 and the second roughness value R2 is at least larger than 0.5 but is smaller than 2 (2>(P1−P2)>0.5). The maximum range is between 0.5-5, and the preferable range is between 0.5-2.

As indicated in FIG. 5, the spacer 13 corresponds to the first region A1 of the alignment film; the first region A1 has a first width W1; the second region A2 has a second width W2; the vertical projection of the spacer 13 on the second substrate 12 has a maximum width W_{PS}; the light-shielding layer 122 corresponds to the spacer 13 by a width W_{BM′}. In an embodiment, the first width W1 of the first region A1 is larger than a maximum width W_{PS} of the vertical projection of the spacer 13 on the second substrate 12, and the first width W1 is smaller than the width W_{BM′} by which the light-shielding layer 122 corresponds to the spacer 13 (that is, W_{PS}<W1<W_{BM′}), wherein 10% of the spacer height H (that is, 0.1 H) is used as a reference of the maximum width W_{PS} of the vertical projection of the spacer 13.

As indicated in FIG. 5, distance D refers to the distance from an edge of the light-shielding layer 122 to an edge of the spacer 13; distance d refers to the distance from an edge of the light-shielding region of the mask 30 to an edge of the spacer 13; distance (D-d) from an edge of the light-shielding layer 122 to an edge of the light-shielding region of the mask 30 is defined as the second width W2 of the second region A2. In an embodiment, distance D refers to the distance from an edge of the light-shielding layer 122 to an edge of 10% of the height H of the spacer 13 (that is, 0.1 H); distance d refers to the distance from an edge of the light-shielding region of the mask 30 to an edge of 10% of the spacer height H (that is, 0.1 H). In an embodiment, the range of the second width W2 is between 0.3 D-0.7 D, and satisfies:

[(W_{BM′}−W_{PS})/2]×0.3≦W2≦[(W_{BM′}−W_{PS})/2]×0.7.

In an embodiment, the second width W2 is 0.5 D, and satisfies:

W2=[(W_{BM′}−W_{PS})/2]×0.5

As disclosed in the descriptions of FIG. 3A and FIG. 3B, the display panel of the present embodiment can adjust the pre-tilt angle of the liquid crystal molecules near the spacer 13 through the increase in the alignment force adjacent to the spacer 13, such that the light leakage region R₀′ formed near the spacer 13 of the present embodiment is smaller than the conventional light leakage region R₀, and the width W_{BM′} (FIG. 3B) of the light-shielding layer (such as black matrix) correspondingly shielding the light leakage region R₀′ of the present embodiment is narrower than the width W_{BM} (FIG. 3A) of the conventional light-shielding layer. In an embodiment, the width W_{BM′} by which the light-shielding layer 122 corresponds to the spacer 13 is larger than or equal to 40 μm but is smaller than or equal to 150 μm.

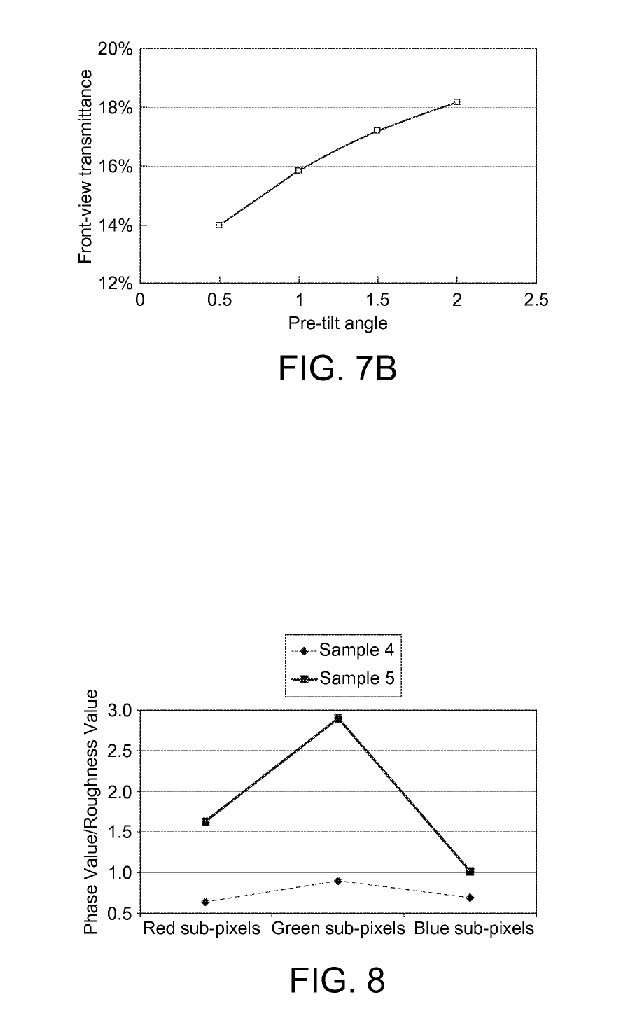

It is assumed that the display panel is equipped with a color filter layer and RGB sub-pixels are used. Since human eyes are most sensitive to the green color and green sub-pixel has largest influence on pixel transmittance, it is desirable that the transmittance of green sub-pixels can be increased in practical design. FIG. 7A shows several patterns of dark fringes corresponding to the pre-tilt angles of 0.5, 1, 1.5 and 2 according to an embodiment of the disclosure. FIG. 7B shows a relationship of front-view transmittance versus pre-tilt angles of 0.5, 1, 1.5 and 2 according to an embodiment of the disclosure. As indicated in FIG. 7A and FIG. 7B, the larger the pre-tilt angle, the narrower the dark fringes and the higher the front-view transmittance. The alignment force affects the pre-tilt angle. When the liquid crystal molecules are tilted along the topography of the substrate, the liquid crystal molecules have tilt angles. The stronger the alignment force, the closer the tilt angle of the liquid crystal molecules to the pre-tilt angle. The pre-tilt angle affects the width of dark fringes, and the width of dark fringes further affects the transmittance. By using the implementation of the disclosure, the alignment force on green sub-pixels can be increased (that is, the phase value/roughness value ratio is increased), and the transmittance of the green sub-pixels can be increased accordingly.

Refer to FIG. 5 and FIG. 8. FIG. 8 shows the relationships of the phase value/roughness value ratios of RGB sub-pixels measured at sampling positions (sample 4 and sample 5) according to an embodiment of the disclosure in which the alignment force is improved. In both sample 4 and sample 5, the phase value/roughness value ratio for the alignment film of green sub-pixels is higher than that of the sub-pixels of other colors. This implies that the alignment force of the alignment film in the green sub-pixel region is higher than that in the sub-pixel regions of other colors, and the transmittance of the green sub-pixel region is increased.

Refer to FIG. 1, FIG. 2 and FIG. 5 again. FIG. 2 comprises RGB sub-pixels. With respect to green sub-pixels, in the baking process (an infrared light is used in collaboration with a mask with specific pattern) as indicated in FIG. 5, the green sub-pixel region shielded by the mask has lower temperature, such that the alignment film in the green sub-pixel region has higher degree of phase separation and larger alignment force. In an embodiment, the second substrate 12 comprises a plurality of red color filter regions, a plurality of green color filter regions and a plurality of blue color filter regions; the alignment film corresponding to one of the red color filter regions has a red phase value Sr and a red roughness value Rr; the alignment film corresponding to one of the green color filter regions has a green phase value Sg and a green roughness value Rg; the alignment film corresponding to one of the blue color filter regions has a blue phase value Sb and a blue roughness value Rb. In an embodiment, the ratio Pg (Sg/Rg) of the green phase value Sg to the green roughness value Rg is larger than the ratio Pr (Sr/Rr) of the red phase value Sr to the red roughness value Rr. In an embodiment, the ratio Pg (Sg/Rg) of the green phase value Sg to green roughness value Rg is larger than the ratio Pb (Sb/Rb) of the blue phase value Sb to the blue roughness value Rb.

To summarize, the display panel disclosed in the embodiments of the disclosure can be realized by a display panel having photo alignment film with particular design. The display panel of the disclosure is capable of increasing the alignment force of the alignment film adjacent to the spacer through the increase in the degree of phase separation of the photo alignment film adjacent to the spacer. Under such design, some liquid crystal molecules which were originally affected by the spacer and tilted in the dark state can now have a pre-tilt angle vertical to the spacer, the light leakage region is reduced, and the light leakage and mura surrounding the spacer in the dark state can be reduced, the width of the light-shielding layer can be reduced, and the aperture ratio of pixels can be increased. Also, the transmittance of green sub-pixels can be increased through the increase in the alignment force of the alignment film in the green sub-pixel region. The phase value/roughness value ratio of the AFM data shows that the larger the phase value/roughness value ratio, the higher the degree of phase separation. Moreover, the techniques disclosed in the embodiments of the disclosure are compatible with existing manufacturing process and are capable of significantly reducing light leakage and mura surrounding the spacer without making the manufacturing process complicated or increasing manufacturing cost. Therefore, the techniques disclosed in the embodiments of the disclosure are ideal for mass production.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display panel, comprising:
a first substrate;
a second substrate;
a liquid crystal layer disposed between the first substrate and the second substrate;
a light-shielding layer disposed between the liquid crystal layer and the second substrate;
a spacer disposed between the first substrate and the second substrate; and
an alignment film disposed between the first substrate and the second substrate, and the alignment film comprising:
a first region (A1) near the spacer and having a first phase value (S1) and a first roughness value (R1); and
a second region (A2) adjacent to the first region and positioned outside the first region, and the second region corresponding to the light-shielding layer and having a second phase value (S2) and a second roughness value (R2);
wherein a ratio P1 (S1/R1) of the first phase value to the first roughness value is larger than a ratio P2 (S2/R2) of the second phase value to the second roughness value.

2. The display panel according to claim 1, wherein the spacer corresponds to the first region (A1) of the alignment film, and the first region (A1) has a first width W1 larger than a maximum width W_{PS} of the vertical projection of the spacer on the second substrate, but the first width W1 is smaller than a width W_{BM} of the light-shielding layer corresponding to the spacer.

3. The display panel according to claim 1, wherein the spacer corresponds to the first region (A1) of the alignment film, and the second region (A2) has a second width W2, the vertical projection of the spacer on the second substrate has a maximum width W_{PS}, and the light-shielding layer corresponding to the spacer has a width W_{BM},
wherein the second width W2 satisfies:
[(W_{BM}−W_{PS})/2]×0.3≦W2≦[(W_{BM}−W_{PS})/2]×0.7.

4. The display panel according to claim 1, wherein the spacer and the alignment film are disposed on the second substrate, and the spacer contacts and covers the spacer.

5. The display panel according to claim 4, further comprising another alignment film disposed on the first substrate and facing the alignment film disposed on the second substrate, wherein the liquid crystal layer is disposed between the two alignment films.

6. The display panel according to claim 1, wherein a difference between the ratio P1 (S1/R1) of the first phase value to the first roughness value and the ratio P2 (S2/R2) of the second phase value to the second roughness value is at least larger than 0.5 but smaller than 5.

7. The display panel according to claim 1, wherein a width (W_{BM}) of the light-shielding layer corresponding to the spacer is larger than or equal to 40 μm but smaller than or equal to 150 μm.

8. The display panel according to claim 1, wherein the second substrate comprises a plurality of red color filter regions, a plurality of green color filter regions and a plurality of blue color filter regions, the alignment film corresponding to one of the red color filter regions has a red phase value (Sr) and a red roughness value (Rr), the alignment film corresponding to one of the green color filter regions has a green phase value (Sg) and a green roughness value (Rg), wherein a ratio Pg (Sg/Rg) of the green phase value (Sg) to the green roughness value (Rg) is larger than a ratio Pr (Sr/Rr) of the red phase value (Sr) to the red roughness value (Rr).

9. The display panel according to claim 1, wherein the second substrate comprises a plurality of red color filter regions, a plurality of green color filter regions and a plurality of blue color filter regions, the alignment film corresponding to one of the green color filter regions has a green phase value (Sg) and a green roughness value (Rg), the alignment film corresponding to one of the blue color filter regions has a blue phase value (Sb) and a blue roughness value (Rb),
wherein a ratio Pg (Sg/Rg) of the green phase value (Sg) to the green roughness value (Rg) is larger than a ratio Pb (Sb/Rb) of the blue phase value (Sb) to the blue roughness value (Rb).

10. The display panel according to claim 1, further comprising:
a first polarizer positioned outside the first substrate; and
a second polarizer positioned outside the second substrate.

11. A display device, comprising:
a display panel, comprising:
a first substrate;
a second substrate opposite to the first substrate ;
a liquid crystal layer disposed between the first substrate and the second substrate;
a light-shielding layer disposed between the liquid crystal layer and the second substrate;
a spacer disposed between the first substrate and the second substrate, for maintaining a substantially uniform gap between the first substrate and the second substrate; and
an alignment film disposed between the first substrate and the second substrate, and the alignment film comprising:
a first region (A1) near the spacer and having a first phase value (S1) and a first roughness value (R1); and
a second region (A2) adjacent to the first region and positioned outside the first region, wherein the second region corresponds to the light-shielding layer and has a second phase value (S2) and a second roughness value (R2), and a ratio P1 (S1/R1) of the first phase value to the first roughness value is larger than a ratio P2 (S2/R2) of the second phase value to the second roughness value; and
a backlight module disposed on a side of the display panel for providing a light to the display panel.

12. The display device according to claim 11, wherein the spacer of the display panel corresponds to the first region (A1) of the alignment film, and the first region (A1) has a first width W1 larger than a maximum width W_{PS} of the vertical projection of the spacer on the second substrate, but the first width W1 is smaller than a width W_{BM} of the light-shielding layer corresponding to the spacer.

13. The display device according to claim 11, wherein the spacer of the display panel corresponds to the first region (A1) of the alignment film, the second region (A2) has a second width W2, the vertical projection of the spacer on the second substrate has a maximum width W_{PS}, and the light-shielding layer corresponding to the spacer has a width W_{BM},
wherein the second width W2 satisfies:
[(W_{BM}−W_{PS})/2]×0.3≦W2≦[(W_{BM}−W_{PS})/2]×0.7.

14. The display device according to claim 11, wherein the spacer and the alignment film are disposed on the second substrate, and the alignment film contacts and covers the spacer.

15. The display device according to claim 14, wherein the display panel further comprises another alignment film disposed on the first substrate and facing the alignment film disposed on the second substrate, and the liquid crystal layer is disposed between the two alignment films.

16. The display device according to claim 11, wherein a difference between a ratio P1 (S1/R1) of the first phase value to the first roughness value and a ratio P2 (S2/R2) of the second phase value to the second roughness value is at least larger than 0.5 but smaller than 5.

17. The display device according to claim 11, wherein a width (W_{BM}) of the light-shielding layer of the display panel corresponding to the spacer is larger than or equal to 40 μm but smaller than or equal to 150 μm.

18. The display device according to claim 11, wherein the second substrate of the display panel comprises a plurality of red color filter regions, a plurality of green color filter regions and a plurality of blue color filter regions, the alignment film corresponding to one of the red color filter regions has a red phase value (Sr) and a red roughness value (Rr), and the alignment film corresponding to one of the green color filter regions has a green phase value (Sg) and a green roughness value (Rg), wherein a ratio Pg (Sg/Rg) of the green phase value (Sg) to the green roughness value (Rg) is larger than a ratio Pr (Sr/Rr) of the red phase value (Sr) to the red roughness value (Rr).

19. The display device according to claim 11, wherein the second substrate of the display panel comprises a plurality of red color filter regions, a plurality of green color filter regions and a plurality of blue color filter regions, the alignment film corresponding to one of the green color filter regions has a green phase value (Sg) and a green roughness value (Rg), the alignment film corresponding to one of the blue color filter regions has a blue phase value (Sb) and a blue roughness value (Rb), wherein a ratio Pg (Sg/Rg) of the green phase value (Sg) to the green roughness value (Rg) is larger than a ratio (Sb/Rb) of the blue phase value (Sb) to the blue roughness value (Rb).

20. The display device according to claim 11, wherein the display panel further comprises a first polarizer positioned outside the first substrate and a second polarizer positioned outside the second substrate.
